(19) United States
(12) Patent Application Publication
(10) Pub. No.: US 2010/0282885 A1
(43) Pub. Date: Nov. 11, 2010

(54) GRINDING CONTAINER FOR THE SELECTIVE COLLECTION OF SOLID URBAN WASTE AND VARIOUS SPECIAL ADAPTATIONS FOR EACH TYPE OF WASTE, INCLUDING A DOMESTIC GRINDING CONTAINER

(76) Inventor: Jesus Perez Santafe, Zaragoza (ES)

Correspondence Address: Mark Levy;HINMAN, HOWARD & KATTELL, LLP, 80 Exchange Street, P.O. Box 5250, BINGHAMTON, NY, 13901, US

(21) Appl. No.: 12/597,775

(22) PCT Filed: Apr. 27, 2007
(86) PCT No.: PCT/ES07/70171

§ 371 Date: Mar. 26, 2010

(30) Foreign Application Priority Data
Apr. 27, 2007 (ES) P200701259

(51) Int. Cl. B02C 18/08

(52) U.S. Cl. 241/236; 241/282.1

(57) ABSTRACT

This specialized domestic grinding containers system, the manual version of which is completely environmentally friendly, allows us to reduce the excessive amount of varied urban waste generated by daily consumption, using a system of piercing/crushing blades which are set transversely on their supporting shafts and which, when sufficiently locked together, enable waste to be reduced to one-fifth of the initial volume thereof by specially arranging the shafts and using different types of blades and hammers for each type of waste (plastic, cans, tetra bricks, paper, glass, organic material and another combined blade system for reject waste). The system is essentially characterized in that the movement of the blades is produced by a particular system of gearwheels which, in the manual version, are actuated by opening the upper lid which, facilitated by a simple pedal which assists in opening said lid, actuates the lateral toothed cylinders located inside the container which in turn actuate the gearwheels located inside each of the lateral cylinders which, located at each of the ends of the four blade shafts thereof, rotate the shafts in a special manner in order to actuate a grinding function and to draw waste into the container, greatly reducing the volume thereof. The specialized manual and electric grinding containers and the different stationary and mobile embodiments intended for domestic use reduce the significant time and monetary costs involved in transporting said waste both from homes to containers on public roads and from such public containers to the respective recycling plants thereof. Waste recycling plays a role in preventing the transformation of more natural resources and reducing the abuse of more scarce natural resources and is facilitated through the use of these specific types of grinding containers having the aforementioned specialized blade systems. Thanks to the dual function comprising the lateral oblique torsion and elastic rotation of each blade independently of one another, said containers can help to achieve the recycling objectives imposed by Directive 2004/12/Econ the member states of the European Union, in its second transposition phase, and all that is needed is the will to grind waste (FIGS. 2.2 and 23).

Grinding container for the selective collection of solid urban waste and special different adaptations for each one of the different waste types, including the domestic grinding container.

### INVENTION TECHNICAL AREA

This invention is meant to contribute to the current waste recycling systems through the incorporation of a mechanical system in the current public waste containers that allows for the reduction in volume of the different types of urban solid waste that come from daily human consumption. In this way, this tries to avoid the transformation of more natural resources and thus alleviate the irresponsible and abusive consumption of raw materials that every day are more and more scarce.

This system is based on a simple manual mechanism that consists of a gearwheel system, in which the simple movement of the lid runner on the top of the container is transformed into a rotational movement of blade shafts which reduces the volume of the different urban solid waste types, whether they are packages, paper cans, organic materials, rejects and even glass, through a varied blade system adapted to each one of the different waste types and that in the case of glass is replaced by a disk hammer system, sufficing to move it with simple wish of wanting to do so, helped by a pedal which needs our body weight to give more force to these grinding-reducing blades (a pedal which is essential in the case of metal cans, because of their hardness).

This invention, in its manual version, is completely ecological in its usage given that it does not consume any type of energy, due to its mechanical-manual form. Trying to collaborate with the different European powers (autonomous and regional state administrations) in the fulfillment of the 2004/12/CE Directive that imposes on the member states of the European Union the obligation of adopting the means to attain, in the current second phase of its transpositions, the following objectives: d) by Dec. 31, 2008 at the latest between a minimum of 55% and a maximum of 80% of the packaging waste weight will be recycled, e) by Dec. 31, 2008 the following minimum recycling objectives of the materials contained in packaging waste will be reached: i) 60% of glass weight, u) 60% of paper and cardboard weight. Hi) 50% of metal weight. Iv) 22.5% of plastic weight, counting only the material that is transformed again into plastic and v) 15% of wood weight.

### TECHNICAL STATUS

Facing the current selective collection of solid urban waste throughout Europe, which is based on the introduction on the streets of similar waste containers differing only in their color or form, the current system intends a complete innovation in so much that it introduces a system that reduces the volume of this waste achieving a reduction of between five and ten times the volume of the current waste collection systems. Thus, it decreases the expensive transport of so much “space” or “air” caused by the great mass of waste, by its grinding or compacting through an innovative piercing, cutting and crushing blade system and even through glass breaking hammers. Once the different competent Public Administrations demand from the local public services for selective waste collection that the receipt of solid urban waste be mono-material through the introduction of a specialized container types for the collection of each one of the different waste types, to be introduced progressively, in such a way that they demand the existence of at least the following container types.
a specific container for PEAD, PEBD, PS, PP and PET (for example. yellow) plastic packaging—another type of container for cans (for example, gray);
another type for the collection of tetra bricks (for example, silver);
another type of container for paper and cardboard (for example, blue);
another for the collection of glass (for example, light green);
another for the collection of organic materials (for example, brown), and another for the collection for reject waste (for example, the traditional color is dark green).

Afterwards, this variety could be increased to other specialized containers such as those that could be introduced in the current public Green Areas especially created by each council for an even more specialized selective collection like the collection of: —batteries, white goods, wooden furniture or boards and other large waste, and even textiles or other potentially environmentally contaminating domestic waste like, used oil or non-degradable chemical products like cleaners, varnishes, paints, detergents, medicine, etc.

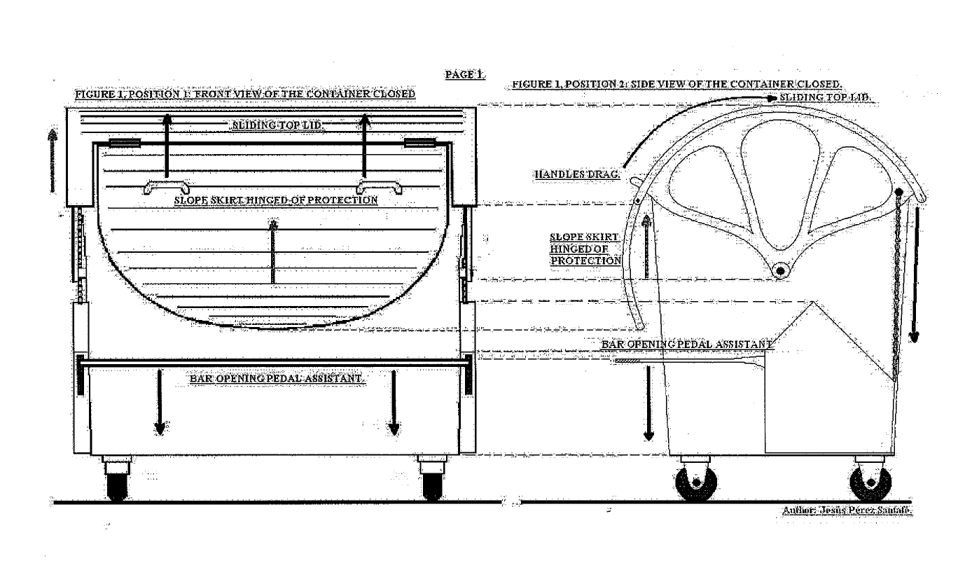

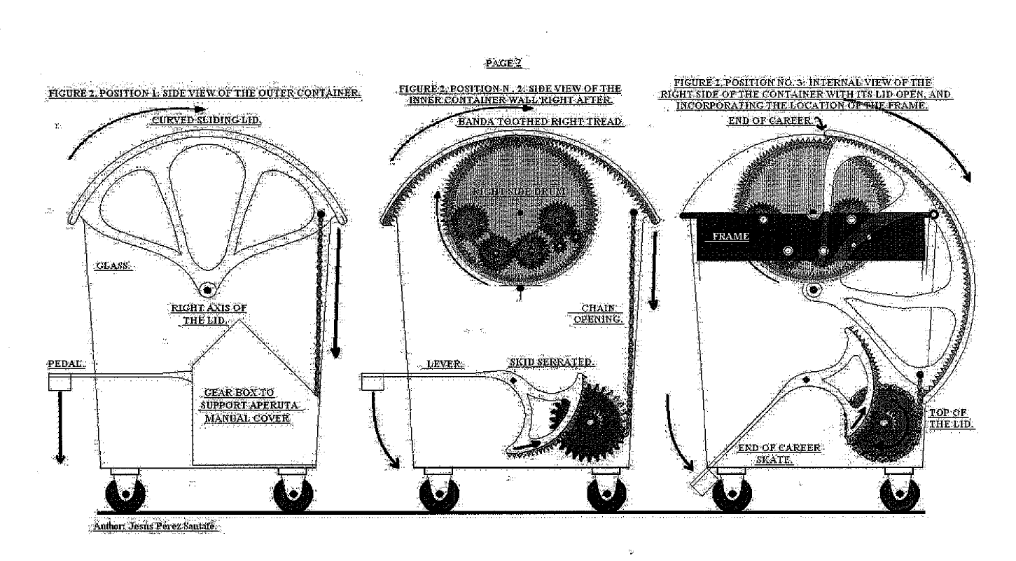

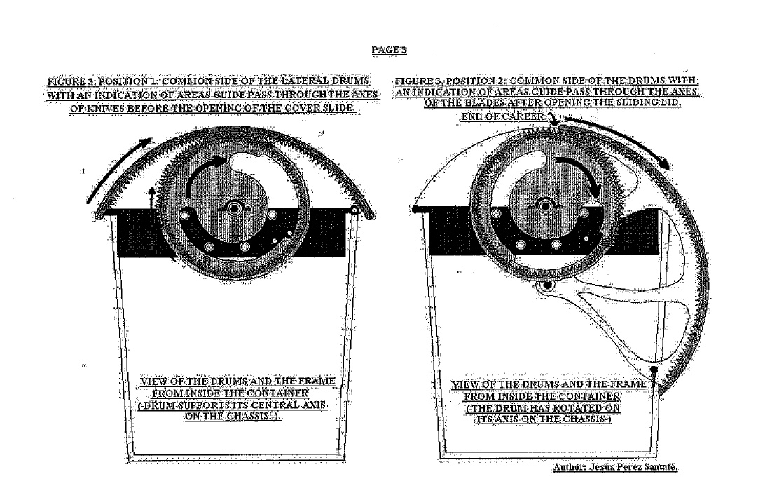

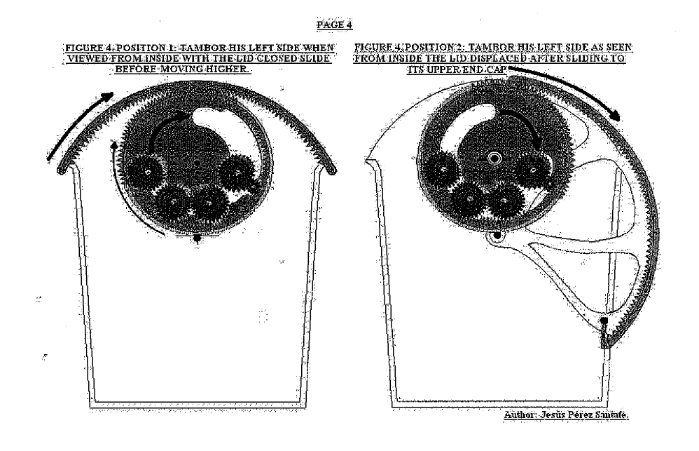

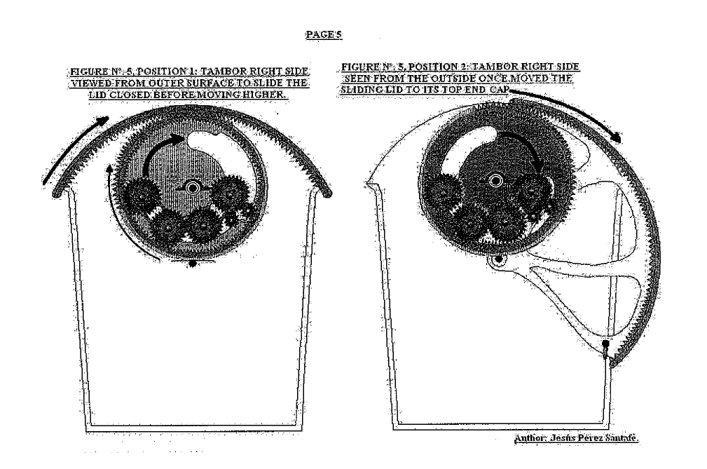

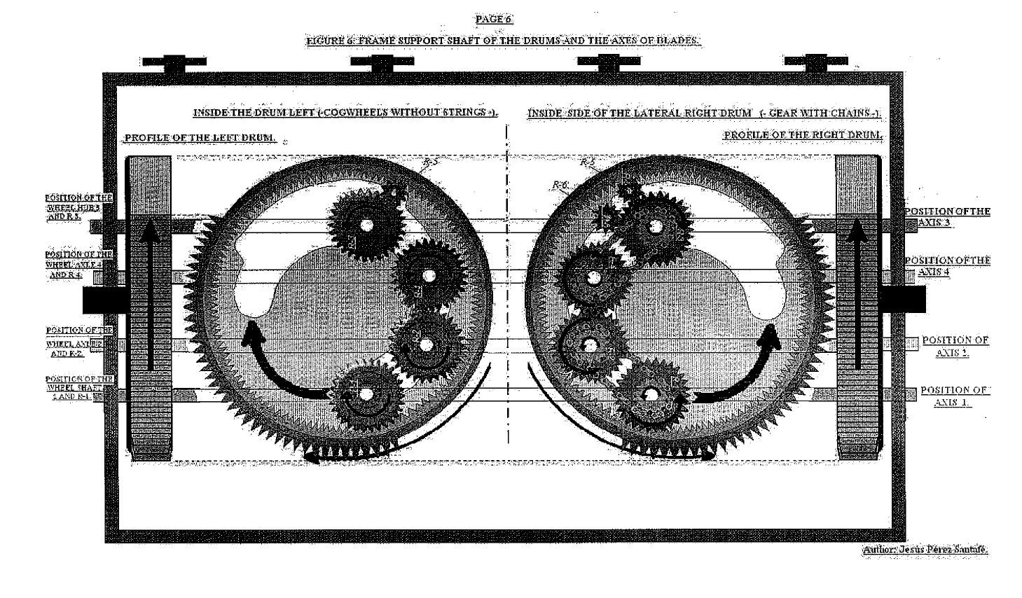

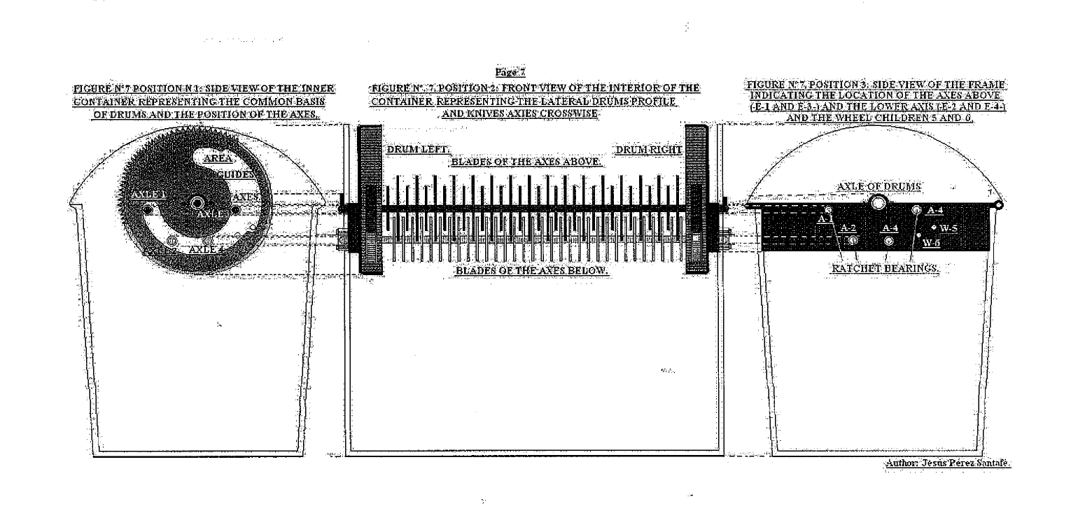

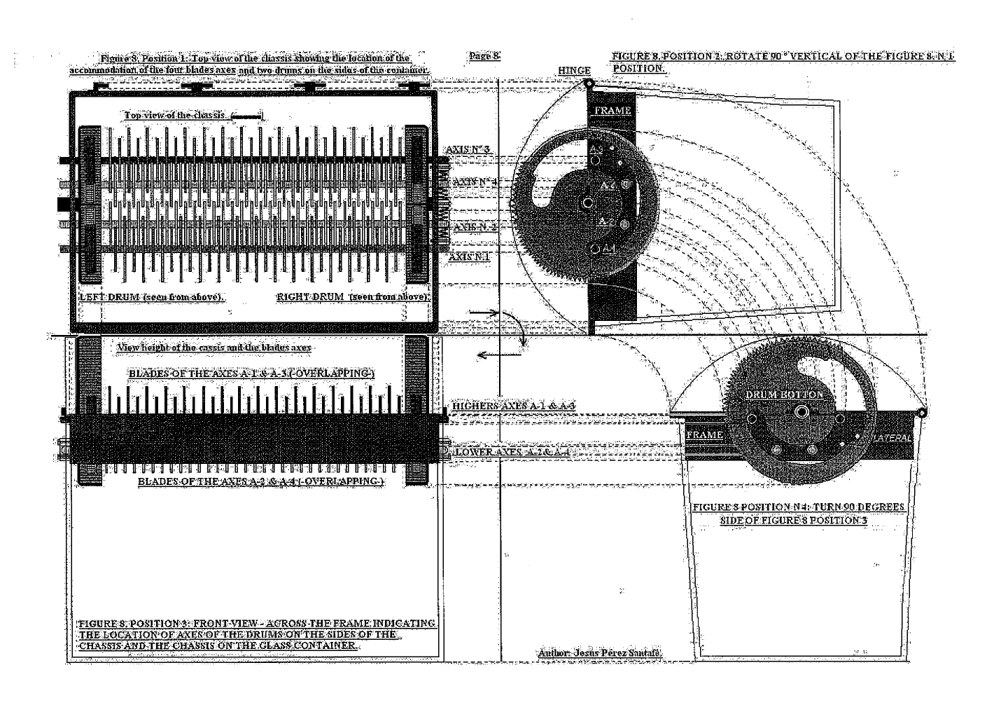

Entering into the technical side of the invention, the first phase of the mechanical grinding is based on the transformation of the mechanical motion produced by the horizontal movement of the curved running lid on the upper part of the container towards its rear. It transforms this opening movement into the circular motion of the two cylinders of the gearwheels located on the side walls of the container (on the top parts of both the left and right side) thanks to a system of symmetrical teeth that, acting through a running rack, make each cylinder raise like an eyebrow (curved lid) that turns over its eye (or cylinder), given that, finding each cylinder on the top part of the left and right side of the container, the movement of the running lid through its own turning shaft makes the toothed sides located on the lower face of the left and right sides of this lid move the teeth of the upper face or “wearing side” of the each lateral cylinder that is supported on an independent frame, in this way making a circular movement of the side cylinders, as is explained in FIG. 2 positions no 1, 2 and 3. At the same time, with the objective of helping the opening of the running lid by hand, the positioning of a horizontal bar on the lower part of the container's front face is considered (FIG. 1), that with the idea of giving greater strength to the opening of this upper lid, transfers the displacement movement descending from this horizontal bar to an angular movement going down from each one of the lateral levers located on both sides, left and right, of the container in such a way that the movement of its toothed pads found at the bottom of each lever produces the rotation of the smaller concentrically embedded gearwheels on the larger gearwheels located in the lower part of each side of the container. This is caused by the winding of the chain that is wound around each one of the larger gearwheels on each side, that connects directly with the outside corners of the left and right sides of the running lid which is explained in positions 2 and 3 of FIG. 2 with the idea of aiding this lid in its opening through the traction that is done by the chain winding around the gearwheels at the bottom of the container. After this, in a second mechanical phase, although synchronized in time, the movement started by the upper running lid on each one of the two cylinders located in the upper part of the mentioned left and right side walls of the container, upon the production of the synchronized circular rotational movement of each one of the two side cylinders upon their respective shaft (as shown in FIG. 3), the cylinders make the gearwheels in the inside of each cylinder rotate as is clearly shown in FIG. 4 in positions 1 and 2 in respect to the left cylinder, and in FIG. 5, position 1 and 2 in respect to the right cylinder, whose cylinders are shown to be held by their respective shafts, which are found embedded in a rectangular frame by bushings, as shown in FIG. 6.

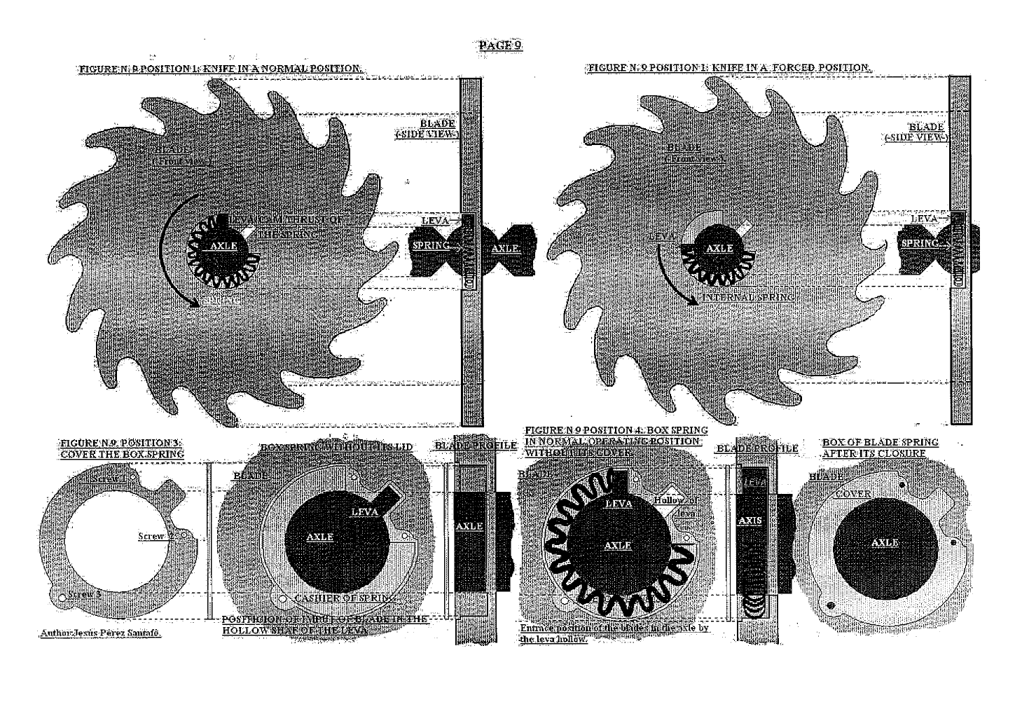

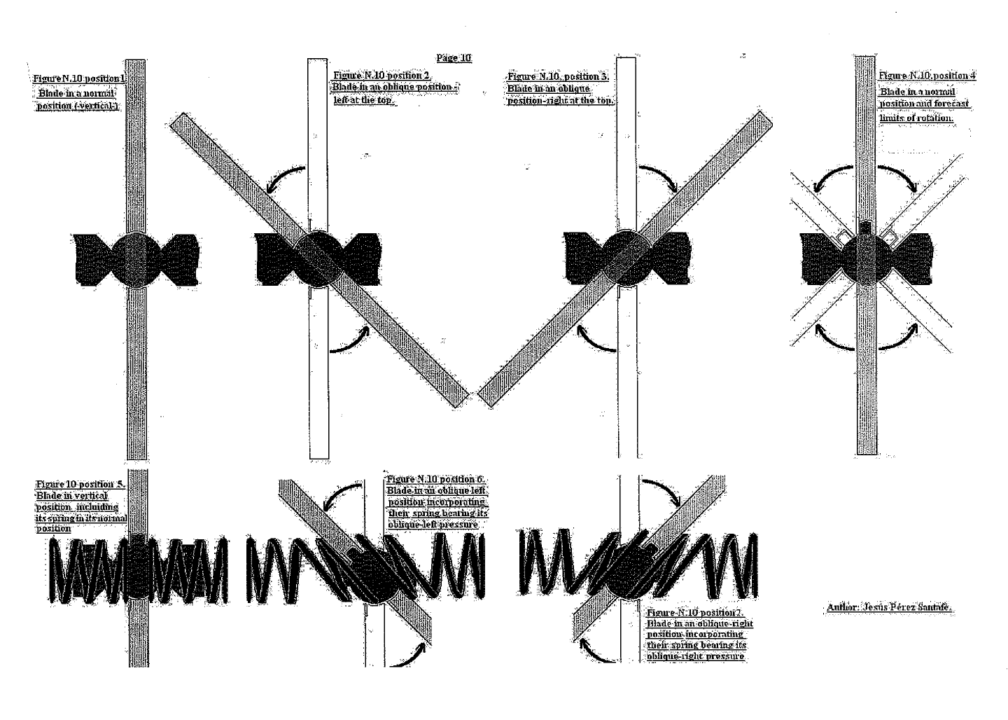

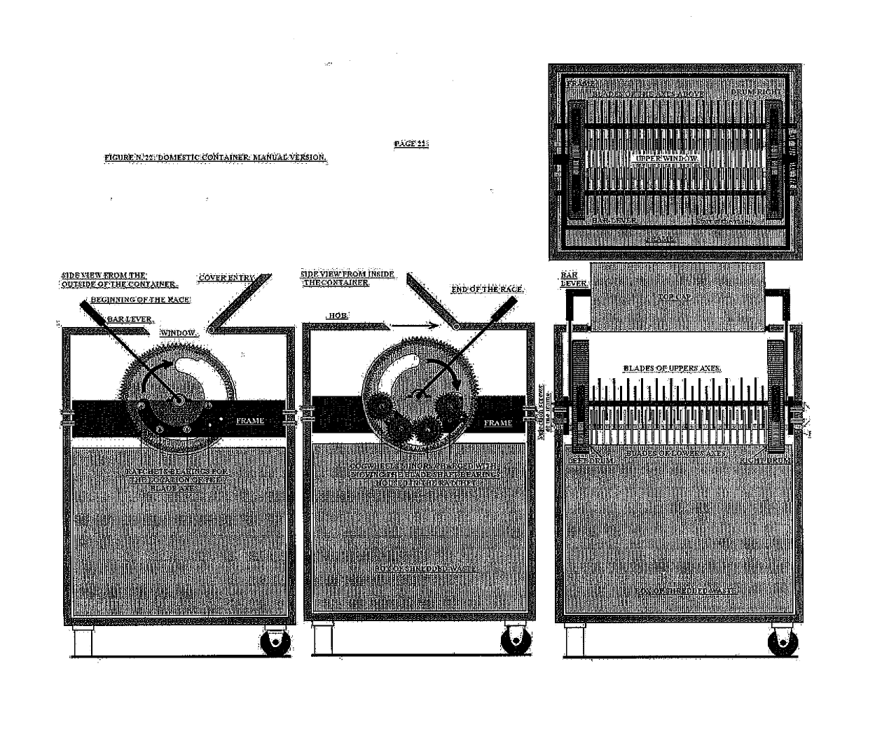

This frame, found on the upper fringe of the inside of the container as internal layering, will be made of a material that is sufficiently resistant to be able to bear the foreseen twisting that the diverse blade shafts that it supports are going to generate, which in the example shown in FIG. 2 and the ones that follow is configured with four blade shafts. These shafts, however, may be of a greater or lesser amount depending on the requirements and the shafts, moved by their respective smaller gearwheels located at the ends of each shaft, are going to be moved by the rotation of the aforementioned lateral cylinders as is explained in FIG. 6, upon locating these smaller gearwheels of the blade shaft within those of the lateral cylinders even though these shafts are born by the left and frame sides of the frame by their own bushings working as a ratchet, located likewise on the left and right edges of each shaft, as can be seen in FIGS. 7 and 8, making this frame as an independent structure in respect to the basin in which it is supported and the fixing to the bottom is guaranteed by several hinges found on the upper part of the containers rear door (FIGS. 6 and 7, position 3 and FIGS. 8 and 20). This is so that the frame is collapsible over the basin and in this way is able to empty the waste introduced into it (packaging, cans, etc). Once these are ground by the movement of the blades placed perpendicularly on the transversal shafts, that are moved synchronically by both cylinders, they are found as we said embedded in the frame through bushings working as ratchets (FIG. 8, positions 1 to 4), both lateral cylinders are also found embedded in the collapsible frame through large bushings.

This is because in the third mechanical phase, although synchronized with the first two, the simultaneous movement of both lateral cylinders caused by the lid produces the following induced and synchronic rotation of each group of the four smaller gearwheels locked between themselves, that are found in each one of the two lateral cylinders in such a way that on one side they are found supporting the four internal gearwheels found with the left cylinder, on the respective left edges of each one of the four blades shafts, and are found on the other side supporting each one of the four internal gearwheel located in the right cylinder on the respective right edges of these same blade shafts; this setup of the gearwheels, located inside each cylinder, causes that the simultaneous turn of each cylinder (caused by the running action of the lid) starts the synchronic turn of each one of the smaller gearwheels located within each one of the cylinders, starting by this the rotation of each one of the blade shafts, whose wheels within each cylinder (R-1, R-2, R-3 and R4), each one with 30 teeth, make a 360° turn of each one of the four blade shafts, in spite that these shafts are really supported over the frame, making this frame, as a result, the real support both for the four blade shafts and the two lateral cylinders, given that all of these are found embedded transversally by bushings in this frame (see FIGS. 6, 7 and 8). Therefore, these cylinders do not support the shafts, they only make them move.

In this same mechanical phase it must be said that the strange set up of the four smaller gearwheels placed in the lower part of each lateral cylinder (as is shown in FIG. 6) causes that the gearwheels r-1 and r-2, both the same radius, with 30 teeth fitting the toothed side of the internal tread of the aforementioned cylinder (whose internal cylinder has 120 internal teeth) to rotate in the same synchronic way to displace the running lid of the container towards the rear wall of the container, causing by this displacement that both lateral cylinders rotate over their respective shafts in the frame, in the following directions:

its left cylinder in an anticlockwise direction (seen from outside the container) and the right cylinder in a clockwise direction (seen in the same way from outside the container), producing by this the synchronic movement of the four gearwheels located within each cylinder with the following effects. Firstly (see FIG. 6) r-1 and r-2 of the left cylinder (-T-L-) rotate in a clockwise direction (seen from within the container) while the internal gearwheels r-3 and r-4 (identical to r-1 and r-2 in construction) rotate in an anticlockwise direction (seen in the same way from inside the container) by an alternating action of the initial rotation of the cylinder that causes the interposition of the smaller internal wheel r-5 (in the same FIG. 6) whose intermediation changes the movement that in the clockwise direction produces the tread strip of the internal ring of the cylinder, passing on to the bordering r-3 wheel a contrary movement, an anticlockwise one identical to the inverse function produced at the same time by the r-2 wheel to the r-4, which having the same bordering tread, the drive wheel r-2 causes the one bordering it r-4 an opposite movement, producing an identical inverse process in the right cylinder.

By this and as a way of explaining it, as a fourth effect of the initial mechanical movement, the rotation of the grinding shafts, it must be specified that, in the case of the 1 and 2 shafts (e-1 and e-2) their rotation is going to be, within the left cylinder, in a clockwise direction if we look from the inside of the container, at the same time that these same shafts e-1 and e-2 rotate within the right cylinder in an anticlockwise direction if we look from inside the container, while in the case of the shafts 3 and 4 it is going to be the opposite of the rotation of the shafts 1 and 2 both in the left cylinder and the right one, which is why it is going to produce a synchronic movement and at the same time in the opposite sense both between the superior two blade shafts between themselves (e-1 and e-3) as in between the two lower shafts (e-2 and e-4) between themselves, given that the first ones have as a role to bring the deposited waste nearer to the central part of the container for its grinding, rotating both superior shafts e-1 and e-3 in opposite directions, as they push and initially crush this waste, while they bring them closer to the lower e-2 and e-4 shafts, which through their grinding role ends up drawing them in, as they rotate in opposite directions while they are grinding the waste that they have brought closer to the upper blade shafts, until these fall already ground to the bottom of the container basin.

### Grinding System:

Even if the compression system for crushing the waste through the locked or partially crossed intersection between the blades of their shafts is the same for all waste types, except glass (which as shown shortly is done by a hammer system), however, the form of the disc blades varies depending on the type or waste to be ground, although in all of these, this new blade system is characterized because the grip of these blades to their shafts is not fixed, as some electric grinders incorporate, but mobile, in two directions:

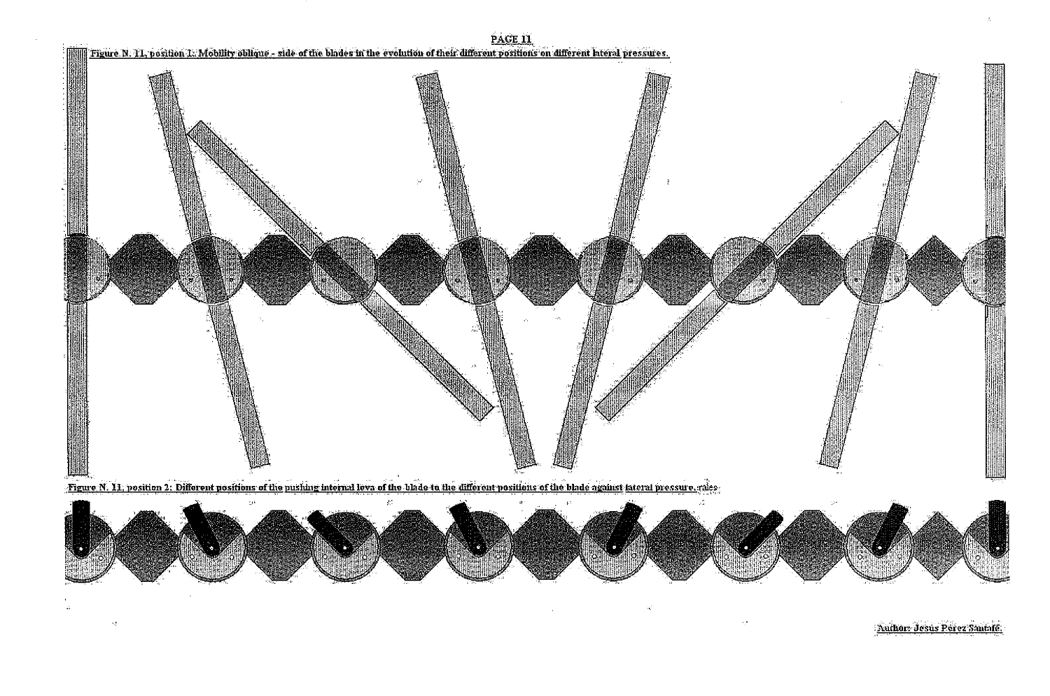

A) First, it is mobile in its rotational grip, which allows the blade to stop or brake even though its shaft continues rotating, while it allows its resistant internal spring, found in the axial grip zone of the blade around the shaft, allowing in this way that the blade gets the necessary tolerance that the grinding of the strongest ill-suited materials that are inevitably in nearly all waste require, and even though the spring progressively allows this through, it ends on reaching the maximum contraction of the spring (located around the shaft), whose internal lifting of the shaft will not continue given the initial braking of its blade (see FIG. 9, positions 1 to 4) causing, by the mechanical tolerance limit, a very efficient final short impulse snap of the blade for the grinding of the different types of waste. It should be taken into account that for each type of waste a pretty strong spring type can be incorporated; the spacing of the circular spring can be regulated by the length of it, for example, through the regulation of the spring by screwing into its circular storage casing.

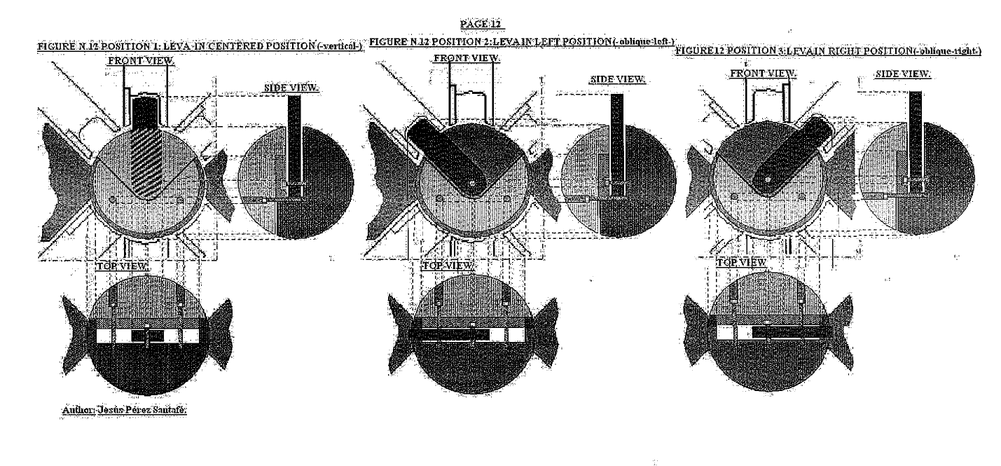

B) Secondly, this blade system with rotational tolerance (through the independent mobility of its shaft) sets a second anti-blocking system that allows the slanted-sideways movement of the blade over the perpendicular surface of the shaft where the blade is, abandoning its initial parallelism with the rest of the blades, by which its occasional slanted unhinging allows that the non-grindable waste, due to their excessive hardness or size, which would block the working of the grinding shafts, can pass as is explained in FIGS. 10,11 and 12.

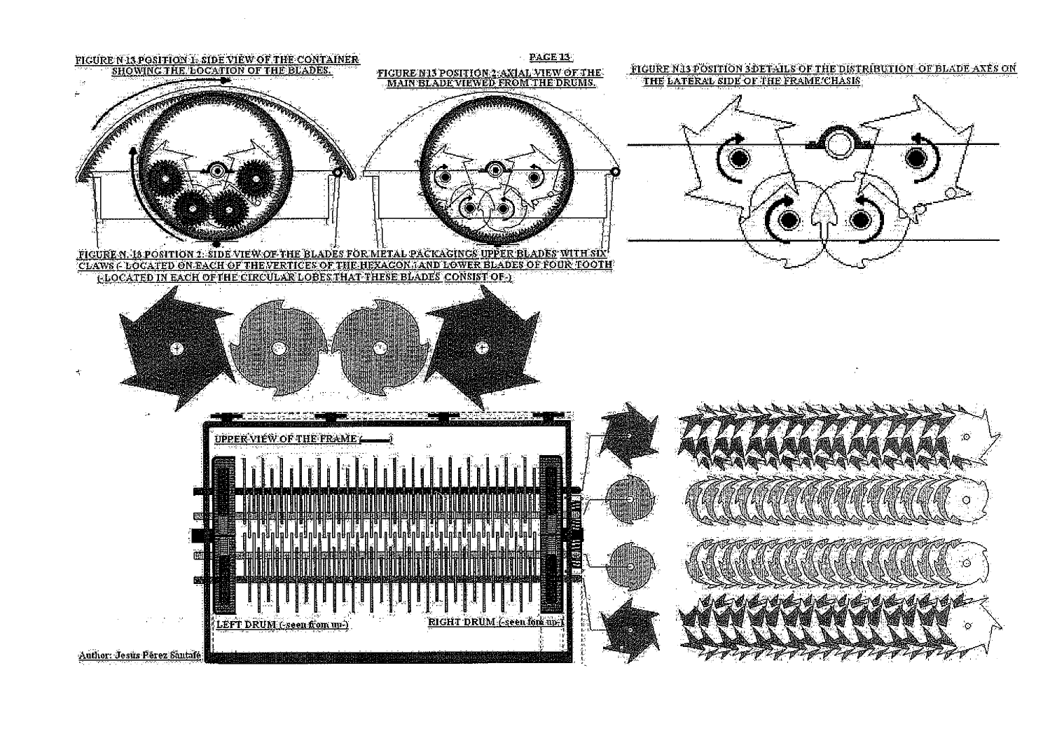

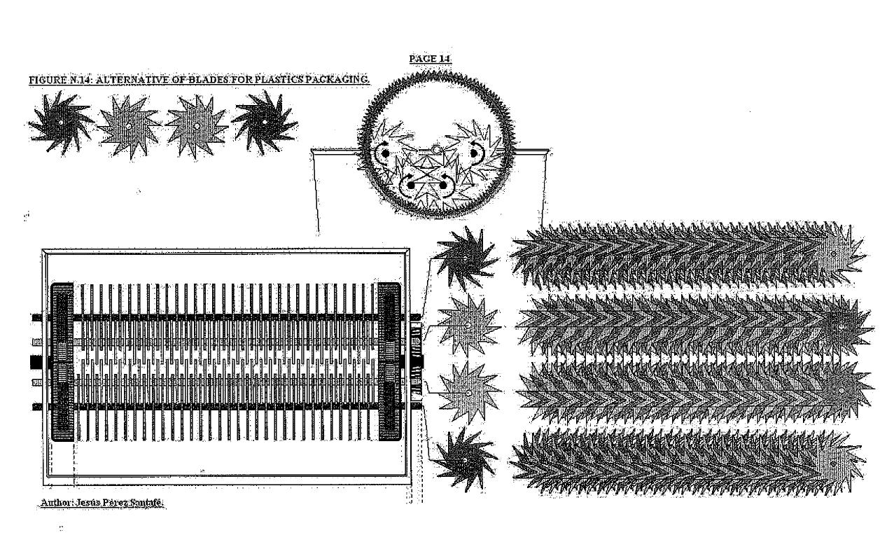

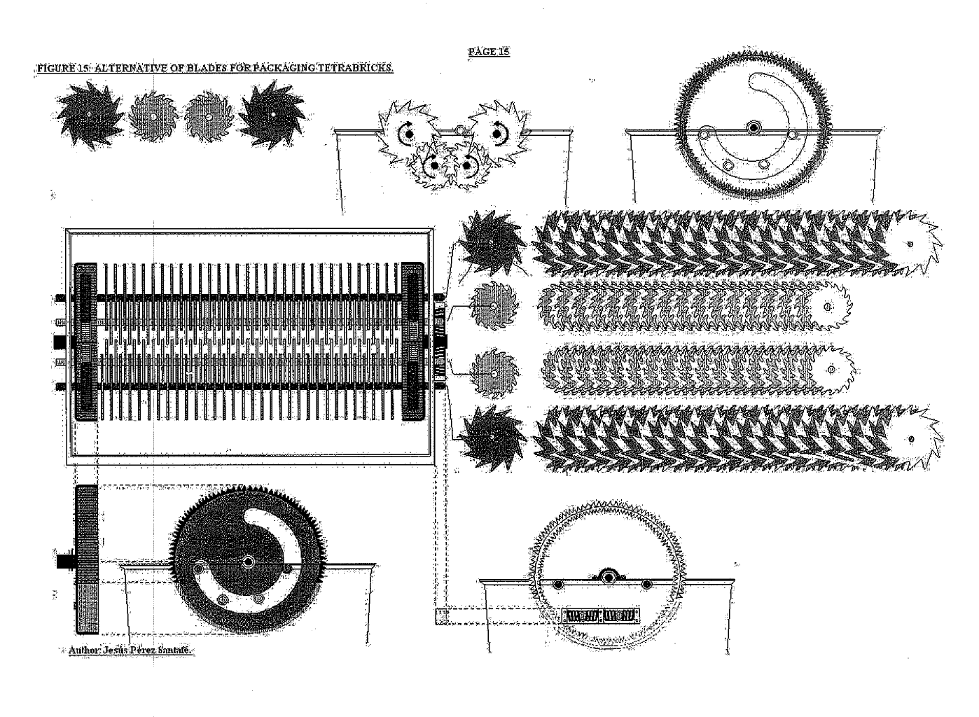

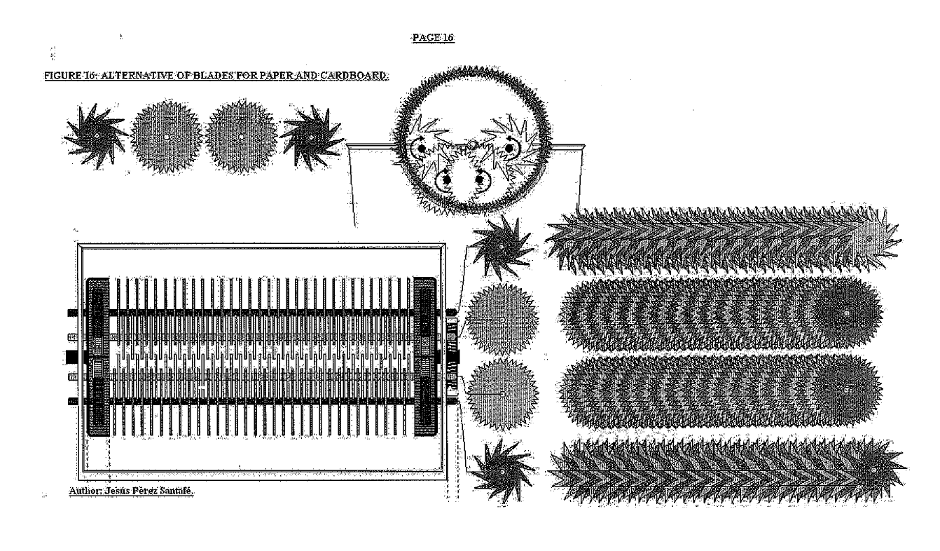

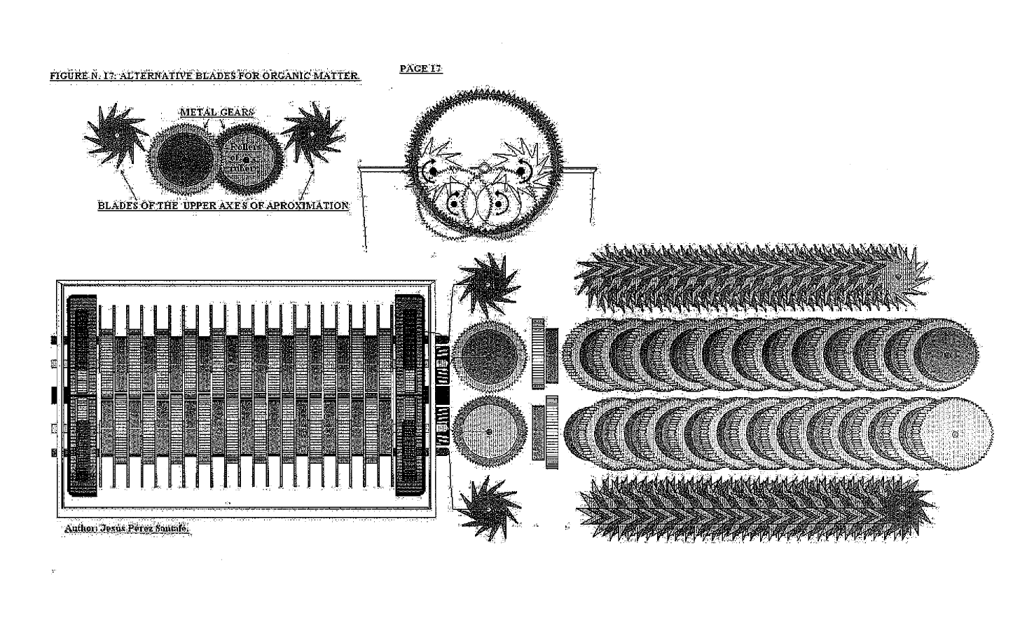

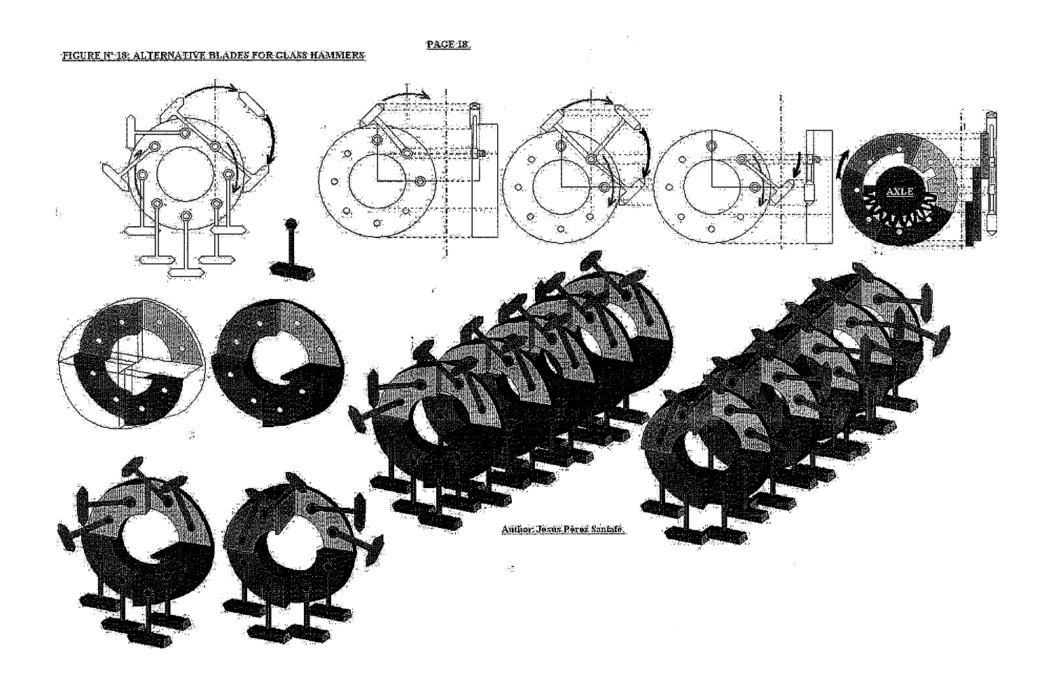

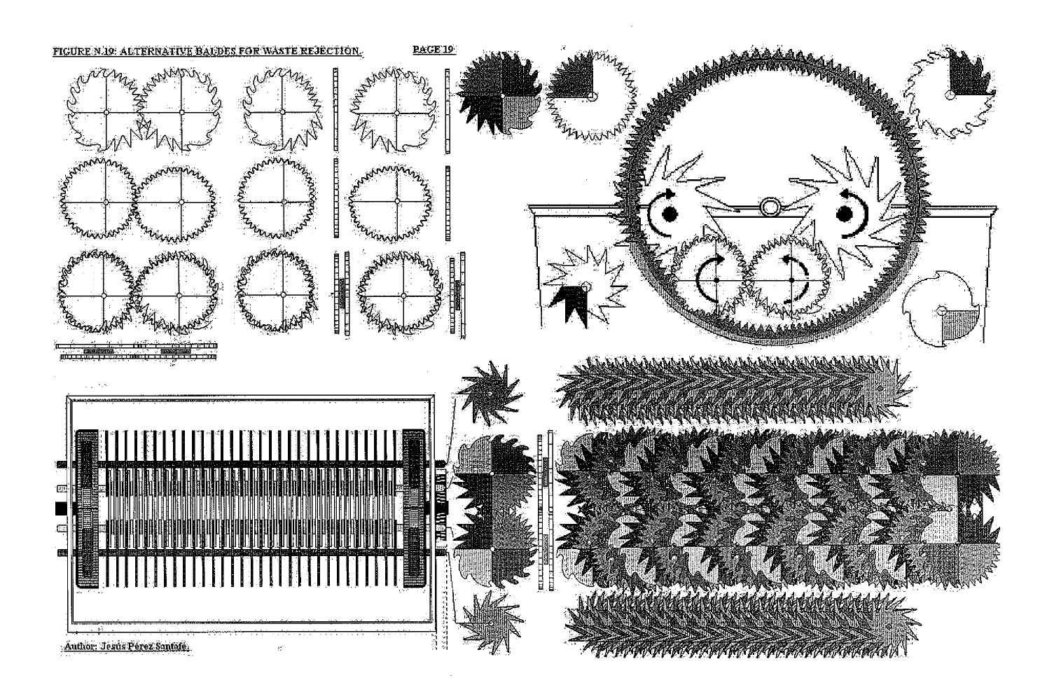

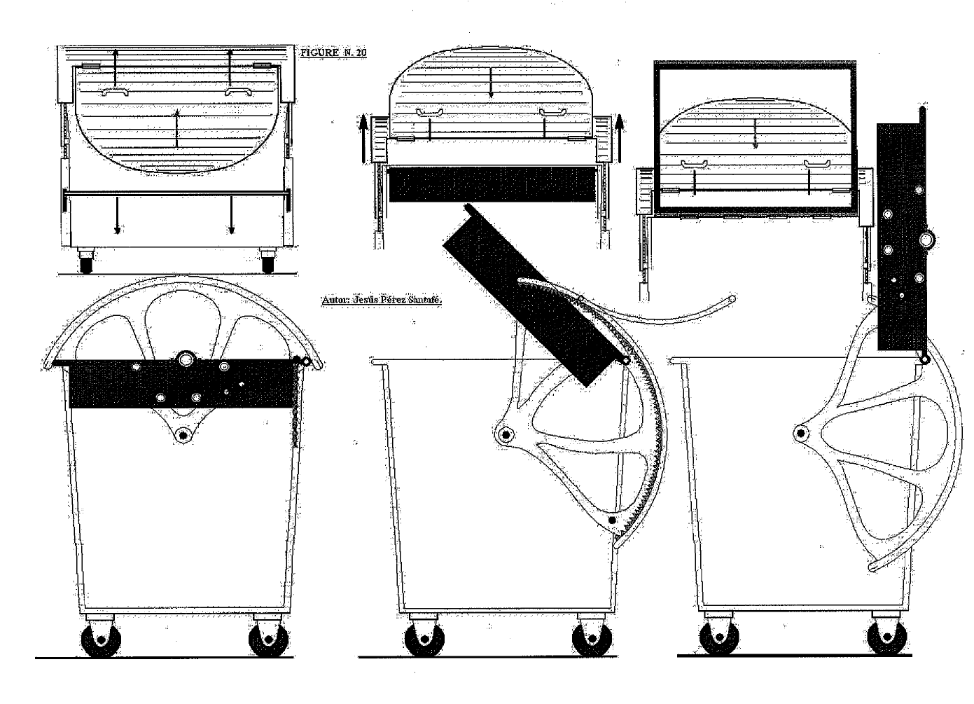

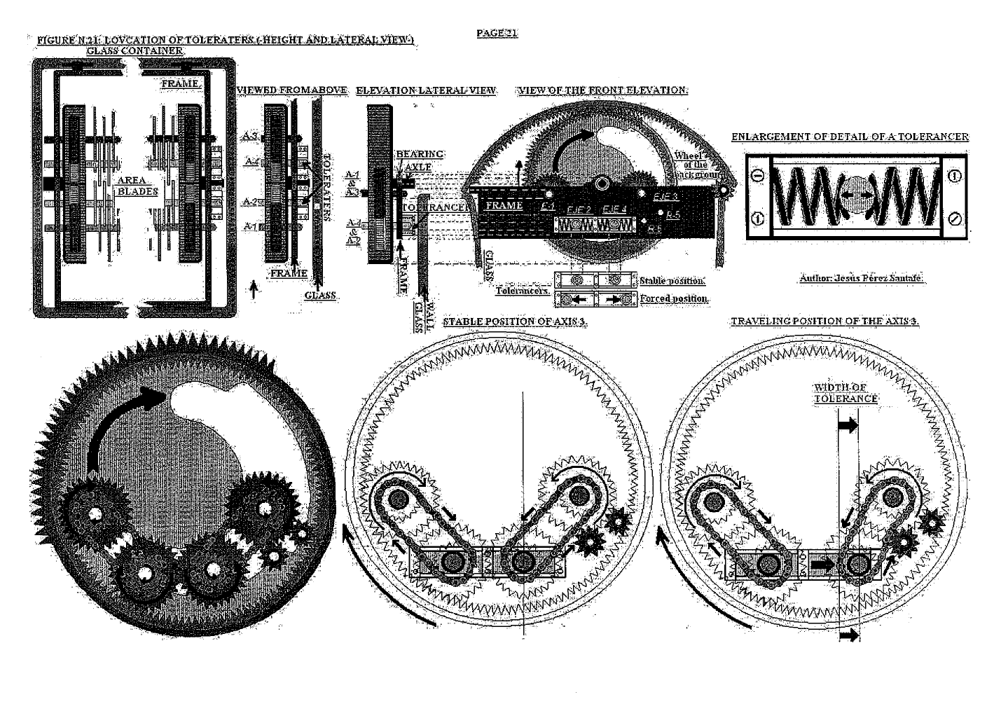

In terms of the design of each blade type, it is proposed that in the case of the metal cans, the blades should be blunt and strong (as drawn in FIG. 13 with six claws on the blades of the upper shafts and four on the lower blades) while in the case of plastic packaging, it is suggested that the blade incorporates a series of much shorter cams (which are drawn in FIG. 14 with twelve claws on the blades of the upper shafts and another twelve claws on the lower blades). In the case of the tetra bricks, its blades must be finer and have sharper edges (drawn in FIG. 15 with twelve claws on the blades of the upper shafts and sixteen claws on the lower blades) establishing at the same time that in the case of the paper or cardboard, its blades should be closer between themselves with the aim of making a tearing cut in strips for which its lower blades will have a traditional saw's teeth, made with 40 teeth which is shown in FIG. 16. For the organic material it is proposed that its shafts include much broader blades, with a section that is several centimeters wide, whose edge is made with much smaller teeth also separating its blades from each other with some strong rubber rollers that allow the crushing of the maximum volume of the organic material in terms of the greater density of the rubber disk inserted between the blade discs of each shaft (FIG. 17). Finally, the glass grinding system is based on a group of insertable discs one after the other, characterized as each of them has a series of hammers attached to the disc by their respective jointed arms (that in our case, are drawn in FIG. 18, in number eight) in such a way that, as each one of the circular sections has several hammers that make up a series of rungs for each disc, the turning of each disc as a “spiral staircase” or like that of a screw producing the hammering of all the points in the dismantling area within the central zone of the container by at least two hammers each one with two rubber discs in each one of the points of the zone set up for breaking the glass, and which in our example on having two hammers in each one of the quadrangular sectors of each disc and with two disc rollers turning in opposite directions, their workings lead to the dismantling with four hammers in each one of the breaking points. Finally, for the collection of reject waste (FIG. 19), it is seen that the blades have a mixture of the different types of aforementioned blades, namely those of: the cans, the plastic packaging, tetra bricks, and the paper-cardboard (excluding those of the organic materials and glass' hammering system), combining each one of these four blade edge types in a rotational way on each quadrangular sector of each blade, inserting each blade in their respective shaft, alternating their positioning of rotation every fourth one, (showing as a result every four blades having a different face next to the other) so that at the end of their continuous 360° turns it guarantees the grinding of the waste in any of the four mentioned grinding types, with the double characteristic, specific for the grinding of this type of heterogeneous waste: that on one side, its blades have a set up that is not circular but more oval (in the shape of an egg) and on the other hand, that its rotation is done over an “eccentric” yet synchronic turning point with the opposite shaft whose opposite blade, also oval, is going to have permanent contact with the other, in spite of its identical oval form, by having this second blade with an equally eccentric rotation but with an opposing focal presentation at 180 degrees from the first (as shown in FIG. 19), producing a regular rotation of its shafts in a serpentine effect in the confrontation area of its blades as seen from above.

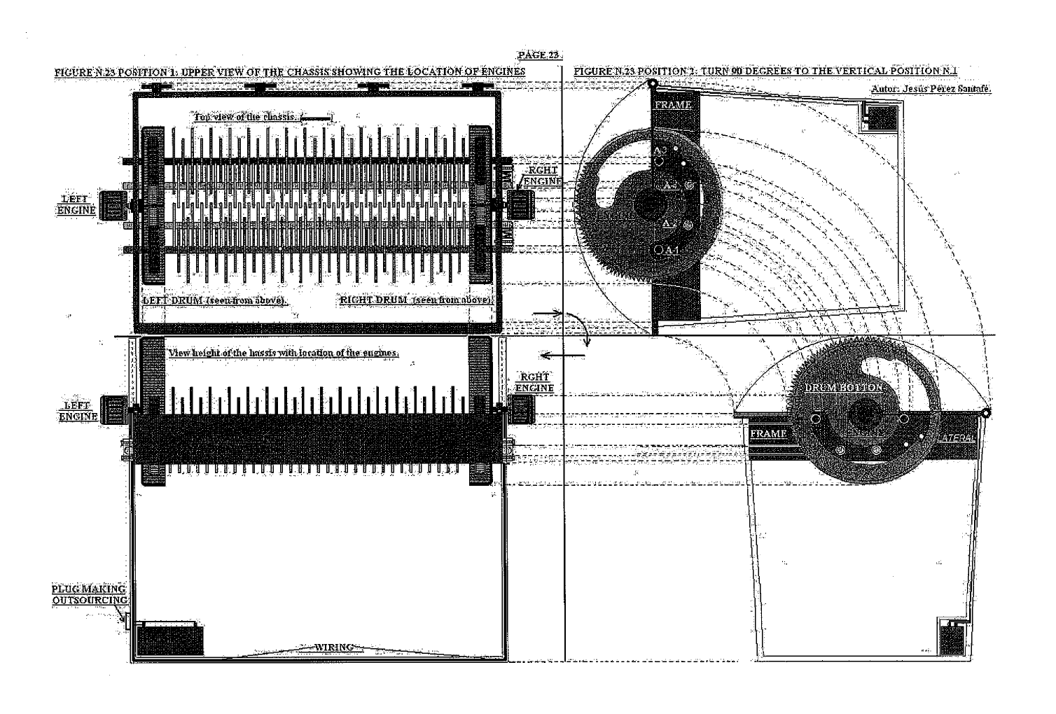

But what makes this mechanical grinding system even more interesting is the role of the ratchet that each bushing located in the shafts of blades embedded in the frames has, given that just like what happens in the rear gearwheel of a bicycle, this allows a random or undefined rotation of the blade shafts in a unique direction: that of the continuous entry of waste, taking complete advantage of the container's capacity, with the gearwheel of the ratchet not allowing the opposite rotation of the blade shafts when they pull back the lateral cylinders in opposite directions, even though the gearwheel allows their rotation in the initial direction indefinitely, impeding in this way the exit of waste in the opposite direction from its prior entry (which is what happens with the rear gearwheel of the bicycle that continues rotating even though one is not pedaling) allowing it to be filled to its maximum limit (this is always subject to the circumstances of each type of waste and the specific composition of each case) slowly and progressively compacting its content through the simple continuous drawing in that its ratchet allows. Therefore, if the one off sliding of the lid is not enough to grind and draw all of the waste in, it will be enough by moving the lid opening again and repeating the action until all has been drawn in. The only limit will be the blocking foreseen that is caused by the rotation of the lateral cylinders through the rise of the frame as a result of rising lift caused by the excessive filling of waste in the upper part of the basin, that starts the leaving of the frame from its initial position, elevating its front flap by moving the fixed hinges located on the side of the bottom of the frame, and by which the frame is going to impede the passing of the running lid, the origin of the movement of all the mechanical system. Another of the characteristics of the grinding system is that the transmission of the sliding movement of the top running lid, that which produces the rotation of the container's two lateral cylinders, is produced not by the sliding of the mentioned container top lid, when it is manually moved to the bottom of the wall for opening, but, on the contrary, the rotational movement of the mentioned cylinders is produced when closing the container lid, the top lid is brought forward for closing which guarantees in this way that the pretty dangerous grinding operations of the waste are going to take place when the lid is completely closed or almost closed, in this way avoiding any possible risks, such as the possible trapping of a tie, that could be produced with the rotation of the blade rollers with the lid open, given that with this configuration, these risks can be avoided, thanks to this inverse roles of attack of the ratchet, which at the same time is helped by the use of a visor type lid, that attached to the running lid through, a 360° hinge, falls vertically from the lid as a front panel when the lid is closed, at the same time as the safety lid cover does, from the height of the grinding chute, when the running lid is found closed at the end of the route of its opening, enough for the tipping of the waste with the lifting of the cover lid, letting this cover lid fall back over the grinding zone over the tipping of this waste, with the grinding not able to begin until the upper running lid of the container begins to be closed, guaranteeing the safety of the grinding operations with the mouth or chute for waste entry already covered. Finally, in terms of the problems that could occur due to the clogging of the grinding shafts as a result of the entry of waste that is broader than the space between the lower grinders, as well as the tolerance that the other spring systems already incorporated in the blades allow, and the slanted twists that can bear these blades between themselves and over their shaft; a final “slack” system has been considered (shown in FIG. 21) whose objective is to overcome the initial resistance that a fixed location of the lower grinders on the frame would produce, consistent with the positioning of a system of “tolerating” or “slack bearing” springs placed on any of the edges (left or right or on both ends of each shaft at the same time), leaving these springs placed perpendicularly in the direction of the respective shaft, within each one of the boxes located on the sides of the frame (as can be seen on the right side for example in positions 1, 2 and 3 of FIG. 21) set up to hold the ends of these lower shafts, whose only job is to allow that an angle can be opened occasionally that lets the habitual parallelism of the two lower blade shafts to be broken to let it be unblocked, just like scissors opening, leaving guaranteed, finally, the rotational control of the ends of these lower shafts within the right cylinder for the encircling effect of a metal safety chain that engages the r-3 and r-4 gearwheels within their cylinder (as shown in positions 2 and 3 of FIG. 21) that in spite that r-4 loses its initial position due to its occasional sliding within its nest-box; it is going to pivot thanks to the tension that the smaller gearwheel r-6 has on the chain, whose tightening shaft is going to make this metallic chain be equally tight in spite of the chain in position of the r-4 gearwheel. Finally, the forced displacement of the lower shaft e-2 is produced due to the slipping of its edge within another identical nest of springs located on the frame. Although this will be in a slanted position and without a chain as its forced displacement is going to follow an ascending slanted direction with this edge condemned to be in permanent driving contact with the right cylinder's internal rim tread. At the same time for the permanent cleaning of the four blade shafts, a metal brush has been placed below each shaft, with the rotation of each one of its spikes in respect to it longitudinal shaft, in a way that its spikes can permanently guarantee the cleaning and unclogging of the waste that can remain stuck between its blades. Its fixing to the frame has been considered for the upper shafts, although for the cleaning of the lower ones, given the possibility that its right edges can be displaced in the available space, the attaching of its brushes is done not to the frame but through a kirby grip fixed directly to the lower shaft to follow them permanently in parallel. At the same time, for the emptying of the container, a pair of curved “hooks” for the opening/closing of lower part of the front side of the frame, although these are normally found hooked to the upper edge of the front face of the container for the effect of pressing their spring on these “hooks”, have been considered. However, it is thought that this pressure can be released by the pressure that the truck's elevating arm brush is going to place on its triggers on placing it in the lower cavity of the front face of the basin, that frees the frame's hooks.

It has also been planned that, optionally, a simple domestic scale with an electronic indicator that has a weighing tray, can be placed on the bottom of the container's basin, between the bottom of the basin and the bottom of the container. Given its low costs, its electrical feed can be done well by a simple battery or through a self-recharging dynamo (of those sold on the market like flashlights recharged by dynamo) with this dynamo placed in any of the ends of the blades shafts. The possibility of even placing other complementary dynamos on the shafts of both lateral cylinders while being able to place its electronic weight indicator on the upper part of the front face of the container so that by its traditional weight memory systems it can indicate to us among other things, about the quantity of kilograms of waste that have been introduced each time that we use this grinder-container, or by the forwarding to a hypothetical council operational control center for data collection, the real weight of its waste or a warning to this center for when the container is full. It is enough for this to add to this circuit an SMS messaging system through a simple mobile phone (whose charging can be done in the same way by battery or through a self-recharging dynamo) in such a way that when the frame over-lifts on the front side as a consequence of being overloaded, it produces a permanent “short-circuit” signal which together with the data on the number of kilos introduced, guarantees that this signal corresponds to a real overloading, with the added advantages that this information can be managed in real time, one can know at all times the containers that are full, and in this way prepare a system to design the routes through a simple GPS navigating system that can organize the most economical routes for their collection given that some search programs exist on the Internet.

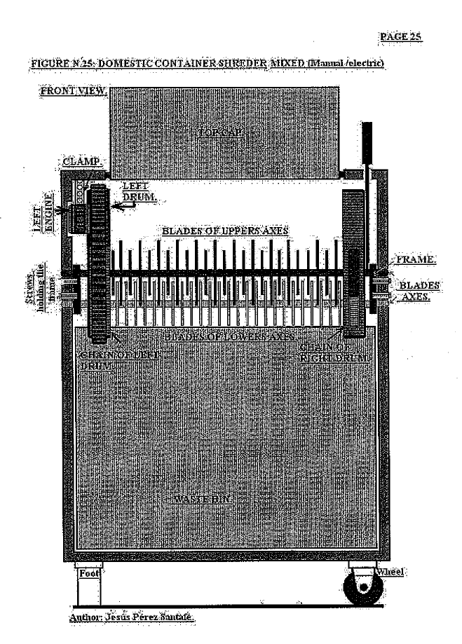

Electrical Alternative: (FIG. 24) As a first but less ecological alternative the mechanical origin caused by the manual displacement of the container's top running lid can be substituted by the positioning of an electrical motor placed on the frame of the container isolated from the basin. It can receive its electricity either from an external supply network or from a portable battery incorporated within the container. This, thus, makes this type of container electrical because the driving force of the cylinders comes now not from the upper lid but from the motor located on its frame whose driving shaft is set on a lateral cylinder, or on both, or in the cylinder through a gearwheel system that guarantees the driving force of each cylinder. As an alternative location, the possibility of placing the motor lengthways on the bottom of the container in the central part of its base is open, in such a way that, upon extending beyond the end of this shaft through the left and right side walls of the container, in its lower central section, these motorized edges of the shafts move each one of the left and right lateral cylinders through large conic teethed transmission shafts and even through pulley belts or gearwheel chains, leaving these motorized transmission chains located in isolation in respect to the waste basin, protected under an independent lateral housing, with an opening through an external cover (with a hinge) for its maintenance or repair also considered, for the case of the belts or the placing of the chains has also been considered, in the upper external part of the basin and under the housing, a cogwheel changing system (similar to the gear changes of a bicycle) to allow for the passing of these belts or lateral transmission chains from the cogwheel of the cylinder's shaft to another identical gearwheel located next to the cogwheel of the cylinder parallel to this, with the objective of allowing by this that, once the cogwheel changing system is started through an external gear level, it can pass the cylinder's cogwheel chain to the parallel cogwheel, and in this way free the lateral cylinders and their frame of their binding to these transmission chains. This can be done in such a way that the frame can have a free exit from its usual position to be able to empty the basin without finding the lateral cylinders chained to their respective drive chains. For the drive chain to be moved through the gearwheel change system, there has to be a tension tolerance of this chain through a complementary tensor wheel implemented through the vertical length of the belt/chain that give the required tolerance.

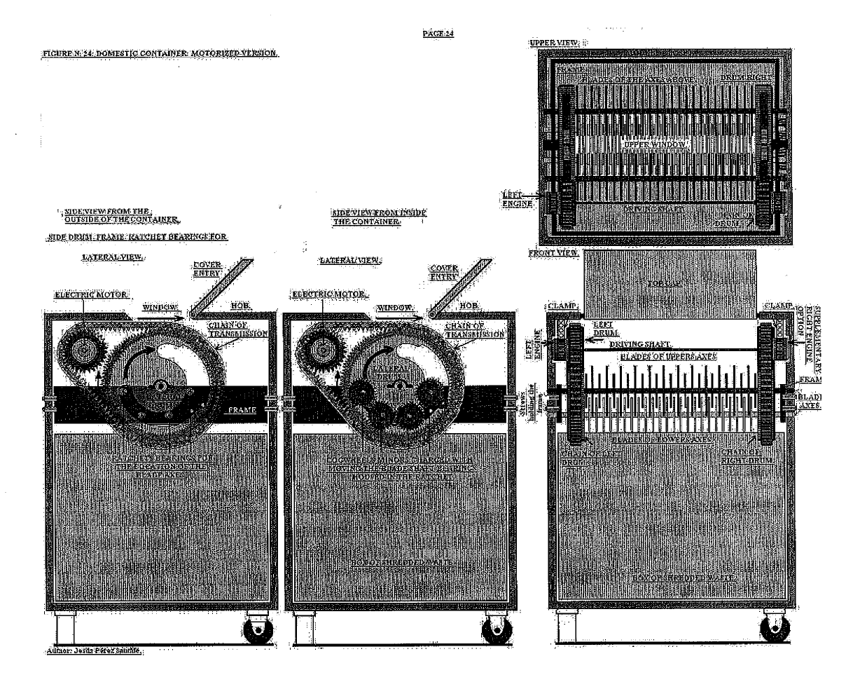

### Alternative of Domestic Grinder Container (FIG. 22):

There is also a domestic variant of the grinder-container although with smaller dimensions but with identical grinding motor alternative, namely manual or electric. However, it also has its mixed system, characterizing the type of domestic grinder-container because although the alternative mobile grinder-container fits or better said has a much reduced wheel than the one meant for use on the streets, it also consider a “fixed” variant of the grinder container with equally reduced dimensions to be located within a closet, to be placed for example on the bench-top in the kitchen, or in the gallery etc. This considers all blade types studied in the basic blades system (although the most suitable system seems to be the reject mixed blade system) adding to this domestic container alternative all the options defined above in the basic or general model; at the same time all these domestic grinder-container variables are characterized by that their safety lid allows the grinder system to start when there is a guarantee that its operation is going to be safe, be it because that when the blades are moving the entry lid is closed (whether its force is mechanical or electrical) or because when the lid is open there is a safety grate located between the lid and the blades that only allows small waste to pass, thus avoiding the entry of parts of the users body; this is aided by the consideration of a switch on the outside on the top next to the grinder container mouth that allows the user to stop the motor and reverse it to unclog, in the case of the electric alternative. Or in the manual system, it has a manual brake lever that stops the rotational action of the blade shafts by triggering the brake rivet located beneath the r-2 wheel in front of the motor contact zone of the cylinder internal tread, which gives movement to the two lower blade shafts.

Double design variety of the grinding blades: If it is considered that every mechanical opening operation of the lid is not enough for the grinding of some specific waste type and it is considered suitable that each shaft of the grinding blades make more than one turn for each lid opening, it will be enough to intermediate a gearwheel with double design between the side tread that touch the lower right and left sides of the lid and the treads of the left and right cylinders, in such a way that the gearwheel that makes drive contact with the lid moves the other gearwheel concentric to it but with double the number of teeth (or triple, quadruple, etc) simultaneously which will be in charge of moving the tread of each lateral cylinder.

1-27. (canceled)

28. An apparatus for grinding solid waste, comprising:
a first plurality of grinding blades parallel to one another and disposed on a first axle perpendicular to an axis thereof;
a second plurality of grinding blades parallel to one another and disposed on a second axle perpendicular to an axis thereof, said axis of said second axle being parallel to said axis of said first axle, wherein said first and second plurality of blades are interleaved and adapted for counter-rotation with respect to each other;
a set of gears operatively connected to each of said first and second axles; and
means for driving said set of gears to effectuate rotation of each set of grinding blades.

29. The apparatus of claim 28, wherein said set of gears comprises at least one of the group: epicyclical, cycloidal, and planetary.

30. The apparatus of claim 28, wherein said means for driving said set of gears is chosen from the group: manual, hand-operated, foot operated, and electric.

31. The apparatus of claim 28, wherein said set of gears is chain driven.

32. The apparatus of claim 28, wherein said axles and said blades are spring loaded.

33. The apparatus of claim 28, wherein said means for preventing retrograde movement of said plurality of blades comprises a ratcheting system.

34. The apparatus of claim 32, wherein said means for separating said first and second axles to prevent jamming comprises an axle backlash tolerance.

35. The apparatus of claim 28, wherein said grinding blades pivot.

36. The apparatus of claim 32, wherein said grinding blades are released when a tough piece of waste is encountered.

37. The apparatus of claim 28, further comprising means for cleaning said grinding blades.

38. The apparatus of claim 28, further comprising a scale for weighing said ground waste material.

39. The apparatus of claim 28, further comprising a global positioning system (GPS) for signaling location of said ground waste material.
